(19) United States
(12) Patent Application Publication
(10) Pub. No.: US 2026/0104826 A1
(43) Pub. Date: Apr. 16, 2026

(54) STORAGE DEVICE INCLUDING NONVOLATILE MEMORY DEVICE AND OPERATING METHOD OF NONVOLATILE MEMORY DEVICE

(71) Applicant: Samsung Electronics Co., Ltd., Suwon-si (KR)

(72) Inventors: Sewon Yun, Suwon-si (KR); Jung-Yun Yun, Suwon-si (KR)

(21) Appl. No.: 19/311,249

(22) Filed: Aug. 27, 2025

(30) Foreign Application Priority Data
Oct. 10, 2024 (KR) 10-2024-0137745

(51) Int. Cl. G06F 3/06

(52) U.S. Cl. CPC G06F 3/0659; G06F 3/0611; G06F 3/0688

(57) ABSTRACT

Provided is a storage device, including a plurality of nonvolatile memory devices including a first nonvolatile memory device and a second nonvolatile memory device, and a storage controller, in which the storage controller transmits a first command to the first nonvolatile memory device and a second command to the second nonvolatile memory device. In response to receiving the first command, the first nonvolatile memory device generates first peak information associated with the first command, and in response to receiving the second command, the second nonvolatile memory device generates second peak information associated with the second command and transmits the second peak information to the first nonvolatile memory device. The first nonvolatile memory device queues the first command in a first command queue based on the first peak information and the second peak information, and determines an execution time point of the first command based on the second peak information.

### CROSS-REFERENCE TO RELATED APPLICATION

This application claims priority to Korean Patent Application No. 10-2024-0137745, filed in the Korean Intellectual Property Office on Oct. 10, 2024, the entire contents of which are hereby incorporated by reference.

### BACKGROUND

A semiconductor memory is classified into a volatile memory device such as a static RAM (SRAM), a dynamic RAM (DRAM), a synchronous DRAM (SDRAM), etc. which loses stored data if power supply is cut off, and a nonvolatile memory device such as a read only memory (ROM), a programmable ROM (PROM), an electrically erasable and programmable ROM (EPROM), a flash memory device, a phase-change RAM (PRAM), a magnetic RAM (MRAM), a respective RAM (RRAM), a ferrroelectric RAM (FRA), etc. in which stored data is retained even when power supply is cut off.

As the performance of electronic devices including semiconductor memories is advanced, electronic devices increasingly include various components, making power management an important issue.

The information described above is intended to improve understanding of the background of the present disclosure, and may include information that does not constitute the related art.

### SUMMARY

The present disclosure relates to a storage device including a nonvolatile memory device and a method of operating the nonvolatile memory device.

The objects to be achieved by the present disclosure are not limited to the above, and other objects not explicitly described herein may be clearly understood by those skilled in the art from the description of the present disclosure.

According to some aspects, a storage device may include a plurality of nonvolatile memory devices including a first nonvolatile memory device and a second nonvolatile memory device, and a storage controller configured to control the plurality of nonvolatile memory devices, in which the storage controller may transmit a first command to the first nonvolatile memory device and a second command to the second nonvolatile memory device, in response to receiving the first command, the first nonvolatile memory device may generate first peak information associated with the first command, in response to receiving the second command, the second nonvolatile memory device may generate second peak information associated with the second command and transmits the second peak information to the first nonvolatile memory device, and the first nonvolatile memory device may queue the first command in a first command queue based on the first peak information and the second peak information, and determine an execution time point of the first command based on the second peak information.

According to some aspects, a storage device may include a plurality of nonvolatile memory devices including a first nonvolatile memory device and a second nonvolatile memory device, and a storage controller configured to control the plurality of nonvolatile memory devices, in which the storage controller may transmit a second command to the second nonvolatile memory device, in response to receiving the second command, the second nonvolatile memory device may generate second peak information associated with the second command and transmit the second peak information to the storage controller, the storage controller may queue a first command in a command queue based on a predetermined threshold and the second peak information, determine a time point for executing the first command by the first nonvolatile memory device based on the second peak information, and transmit the first command to the first nonvolatile memory device at the time point of executing the first command, and in response to receiving the first command, the first nonvolatile memory device may generate first peak information associated with the first command and transmit the first peak information to the storage controller.

According to some aspects, a method of operating a nonvolatile memory device may include by a first nonvolatile memory device, receiving a first command from a storage controller, by the first nonvolatile memory device, in response to receiving the first command, generating first peak information associated with the first command, by the first nonvolatile memory device, receiving second peak information associated with a second command from a second nonvolatile memory device, by the first nonvolatile memory device, queuing the first command in a first command queue based on the first peak information and the second peak information, and determining an execution time point of the first command based on the second peak information.

According to various aspects of the present disclosure, the nonvolatile memory device may queue a command in the command queue and determine an execution time point of the command based on the peak information received from another nonvolatile memory device. With this configuration, power consumed by the storage device including the nonvolatile memory device can be managed below a power budget.

According to various aspects of the present disclosure, after queuing a command, the nonvolatile memory device may complete the execution of the command without delay from the time point at which the command is executed. As a result, it is possible to ensure the uniformity of the busy period during which the command is executed.

The effects that can be obtained through the present disclosure are not limited to those described above. Technical effects not explicitly described herein will be clearly understood by those skilled in the art from the description of the present disclosure described below.

### BRIEF DESCRIPTION OF THE DRAWINGS

The above and other implementations and features of the present disclosure will become more apparent by describing in detail example implementations thereof with reference to the attached drawings, in which:

FIG. 1 is a block diagram provided to explain a storage system according to some aspects;

FIG. 2 is a block diagram provided to explain a storage device according to some aspects;

FIG. 3 is a block diagram provided to explain a storage device according to some aspects;

FIG. 4 is a block diagram provided to explain a detailed configuration of a nonvolatile memory device;

FIG. 5A is a diagram provided to explain a structure for sharing information among a plurality of memory chips;

FIG. 5B is a diagram provided to explain a structure for sharing information among a plurality of memory chips;

FIG. 6 is a diagram provided to explain a structure for sharing information among a plurality of memory chips;

FIG. 7 is a block diagram provided to explain detailed configurations of a storage controller and a nonvolatile memory device;

FIGS. 8A and 8B are diagrams illustrating examples of command queuing and execution operations of the memory chips of FIGS. 5A, 5B, and 6 or the storage controller of FIG. 7 according to some aspects;

FIGS. 9A to 9B are diagrams illustrating examples of command queuing and execution operations of the memory chips of FIGS. 5A, 5B, and 6 or the storage controller of FIG. 7 according to some aspects;

FIGS. 10A to 10B are diagrams illustrating examples of command queuing and execution operations of the memory chips of FIG. 5B, and 6 or the storage controller of FIG. 7 according to some aspects;

FIG. 11 is a diagram illustrating examples of command queuing and execution operations of the memory chip in FIG. 6 or the storage controller in FIG. 7 according to some aspects;

FIG. 12 is a block diagram provided to explain a detailed configuration of a nonvolatile memory device;

FIG. 13 is a block diagram illustrating the nonvolatile memory device of FIG. 12;

FIG. 14 is a flowchart provided to explain a method for operating a nonvolatile memory device; and

FIG. 15 is a block diagram illustrating an example in which a storage device according to some aspects is applied to an SSD system.

### DETAILED DESCRIPTION

The disclosure relates to a storage device including a nonvolatile memory device and a method of operating the nonvolatile memory device, and more specifically, to a storage device including a nonvolatile memory device that queues commands in a command queue based on peak information and determines an execution time point of the command based on the peak information, and a method of operating the nonvolatile memory device. In particular, peak currents generated during operation of each memory chip may be related to periods where power consumption is concentrated. The present disclosure covers devices and methods for management of the peak currents.

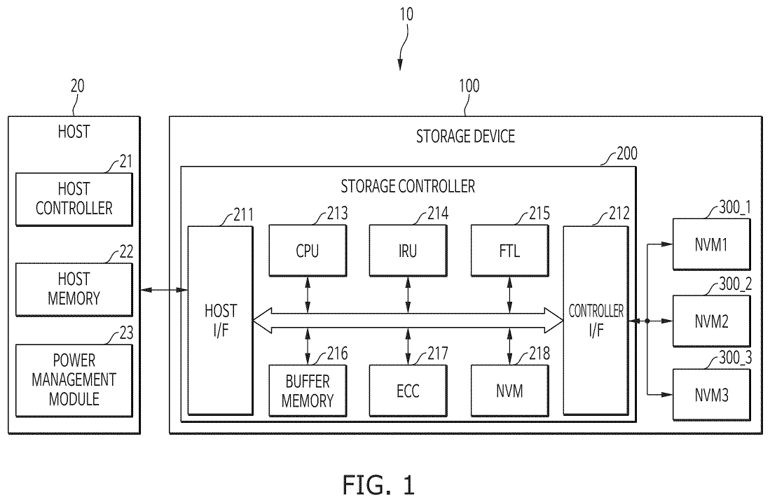

Hereinafter, various examples of the present disclosure will be described with reference to FIGS. 1 to 15. The same reference numerals may refer to the same components throughout the description.

FIG. 1 is a block diagram provided to explain a storage system 10 according to some aspects. Referring to FIG. 1, the storage system 10 may include a host 20 and a storage device 100. In addition, the storage device 100 may include a storage controller 200 and a plurality of nonvolatile memory devices (NVM) 300_1 to 300_3. In addition, in some aspects, the host 20 may include a host controller 21 and a host memory 22. The host memory 22 may serve as a buffer memory for temporarily storing data to be transmitted to the storage device 100 or data transmitted from the storage device 100.

The storage device 100 may include a storage medium for storing data according to a request from the host 20. For example, the storage device 100 may include at least one of a solid state drive (SSD), an embedded memory, and a removable external memory. If the storage device 100 is an SSD, the storage device 100 may be a device conforming to the nonvolatile memory express (NVMe) standard. If the storage device 100 is an embedded memory or external memory, the storage device 100 may be a device conforming to the universal flash storage (UFS) or embedded multi-media card (eMMC) standard. The host 20 and the storage device 100 may generate and transmit packets according to each standard protocol adopted.

If the nonvolatile memory device 300_1 to 300_3 includes a flash memory, the flash memory may include a 2D NAND memory array or a 3D (or vertical or bonding vertical NAND (VNAND)) memory array. As another example, the storage device 100 may include various other types of nonvolatile memories and/or volatile memories. For example, the storage device 100 may include at least one of volatile or nonvolatile memories such as static RAM (SRAM), dynamic RAM (DRAM), synchronous DRAM (SDRAM), read only memory (ROM), programmable ROM (PROM), electrically programmable ROM (EPROM), electrically erasable and programmable ROM (EEPROM), magnetic RAM (MRAM), spin-transfer torque MRAM, conductive bridging RAM (CBRAM), ferroelectric RAM (FeRAM), phase RAM (PRAM), resistive RAM, etc.

The host controller 21 and the host memory 22 may be implemented as separate semiconductor chips. Alternatively, in some aspects, the host controller 21 and host memory 22 may be integrated on the same semiconductor chip. For example, the host controller 21 may be any one of a plurality of modules provided in the application processor, and the application processor may be implemented as a System on Chip (SoC). In addition, the host memory 22 may be an embedded memory provided in the application processor, or may be a volatile memory or memory module disposed outside the application processor.

The host controller 21 may manage an operation of storing data (e.g., write data) of the host memory 22 in the nonvolatile memory devices 300_1 to 300_3, or storing data (e.g., read data) of the nonvolatile memory devices 300_1 to 300_3 in the host memory 22. For example, the host controller 21 may manage the operation of storing user data associated with the execution of a specific program in the nonvolatile memory devices 300_1 to 300_3.

The storage controller 200 may include a host interface 211, a controller interface 212, and a central processing unit (CPU) 213. In addition, the storage controller 200 may further include an Index Read Unit (IRU) 214, a Flash Translation Layer (FTL) 215, a buffer memory 216, an error correction code (ECC) engine 217, and an internal nonvolatile memory 218. The storage controller 200 may further include a working memory in which the flash translation layer 215 is loaded, and the data write and read operations with respect to the nonvolatile memory may be controlled by the CPU 213 executing the flash translation layer 215. For example, the write operation of user data with respect to the nonvolatile memory devices 300_1 to 300_3 may be controlled by the CPU 213 executing the flash translation layer 215.

The host interface 211 may transmit and receive packets to and from the host 20. The packet transmitted from the host 20 to the host interface 211 may include a command and/or data (e.g., user data), etc. to be written to the nonvolatile memory devices 300_1 to 300_3, and the packet transmitted from the host interface 211 to the host 20 may include a response to command, or data read from the nonvolatile memory devices 300_1 to 300_3, etc. The host interface 211 is illustrated as being included in the storage controller 200, but is not limited thereto. For example, the host interface 211 may be located outside the storage controller 200.

The controller interface 212 may transmit data (e.g., user data) to be written to the nonvolatile memory devices 300_1 to 300_3 to the nonvolatile memory devices 300_1 to 300_3, or may receive read data (e.g., user data) from the nonvolatile memory devices 300_1 to 300_3. This controller interface 212 may be implemented to comply with standard protocols such as Toggle or Open NAND Flash Interface (ONFI).

The flash translation layer 215 may perform several functions such as address mapping, wear-leveling, and garbage collection. In addition, the buffer memory 216 may temporarily store data to be written to the nonvolatile memory devices 300_1 to 300_3 or data read from the nonvolatile memory devices 300_1 to 300_3. The buffer memory 216 may be a component provided in the storage controller 200, although it may be disposed outside the storage controller 200.

The ECC engine 217 may perform an error detection and correction function on read data read from the nonvolatile memory devices 300_1 to 300_3. More specifically, the ECC engine 217 may generate a parity bit for the write data to be written to the nonvolatile memory devices 300_1 to 300_3, and the generated parity bit may be stored in the nonvolatile memory devices 300_1 to 300_3 together with the write data. When reading data from the nonvolatile memory devices 300_1 to 300_3, the ECC engine 217 may use the parity bit read from the nonvolatile memory devices 300_1 to 300_3 together with the read data to correct errors in the read data, and output the error-corrected read data.

The host 20 may further include a power management module 23. The power management module 23 may efficiently manage power by distributing necessary power to the components included in the storage system 10. The power management module 23 may determine the total available power in the storage system 10 and may determine the amount of power that may be allocated to the storage device 100 from the determined total power.

The host 20 may transmit the power budget allocated to the storage device 100 to the storage controller 200. The power budget transmitted by the host 20 may be the maximum power value that the storage device 100 can use and the power budget may be a maximum current value or a maximum voltage value that can be allowed in the nonvolatile memory devices 300_1 to 300_3. For example, the power management module 23 may be implemented as Power Management Integrated Circuit (PMIC), but aspects are not limited thereto. If the power management module 23 is implemented as PMIC, the power budget transmitted by the host 20 may be the maximum current limit or maximum power limit that can be provided by the PMIC. In one example, the power budget transmitted from the host 20 to the storage controller 200 may include a predetermined threshold.

The storage controller 200 may determine a time point for transmitting a command to the nonvolatile memory devices 300_1 to 300_3 based on the power budget received from the host 20. If it is determined that the power peak periods of the nonvolatile memory devices 300_1 to 300_3 overlap with each other and that the total power will exceed the power budget, the storage controller 200 may queue the command in a command queue and determine a time point for transmitting the command to the nonvolatile memory devices 300_1 to 300_3. This procedure will be described in detail below.

FIG. 1 illustrates that the power management module 23 is included in the host 20, but aspects are not limited thereto. For example, the power management module 23 may be implemented as a separate component outside the storage device 100 in the storage system 10.

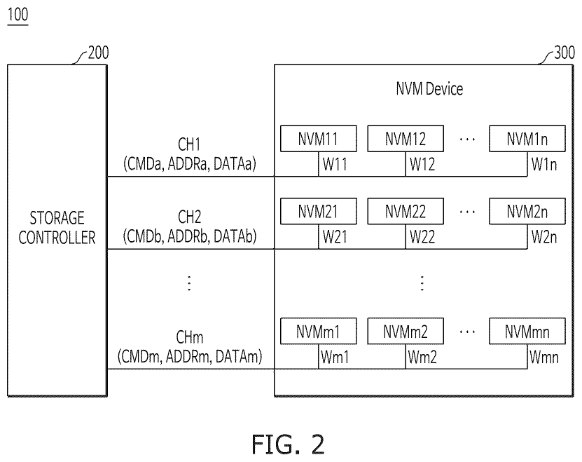

FIG. 2 is a block diagram provided to explain the storage device 100 according to some aspects.

Referring to FIG. 2, a nonvolatile memory device 300 and the storage controller 200 may be connected to each other through a plurality of channels CH1 to CHm. For example, the storage device 100 may be implemented as a storage device such as a solid state drive (SSD).

The nonvolatile memory device 300 may include a plurality of nonvolatile memory devices NVM11 to NVMmn. The plurality of nonvolatile memory devices NVM11 to NVMmn may correspond to the plurality of nonvolatile memory devices 300_1 to 300_3 of FIG. 1.

Each of the nonvolatile memory devices NVM11 to NVMmn may be connected to one of the plurality of channels CH1 to CHm through a corresponding way. Each of the nonvolatile memory devices NVM11 to NVMmn may be implemented in any units of memories that may operate according to an individual command from the storage controller 200. For example, each of the nonvolatile memory devices NVM11 to NVMmn may be implemented as a chip or die, but aspects are not limited thereto.

The storage controller 200 may transmit and receive a data signal to and from the nonvolatile memory device 300 through the plurality of channels CH1 to CHm. For example, the storage controller 200 may transmit commands CMDa to CMDm, addresses ADDRa to ADDRm, and data DATAa to DATAm to the nonvolatile memory device 300 through the channels CH1 to CHm, or may receive the data DATAa to DATAm from the nonvolatile memory device 300. For example, the storage controller 200 may transmit the command CMDa to the nonvolatile memory device NVM11 through the channel CH1 or receive the data DATAa including peak information associated with the command CMDa from the nonvolatile memory device NVM11.

The storage controller 200 may select one of the nonvolatile memory devices 300 connected to the corresponding channel through each channel and transmit and receive signals to and from the selected nonvolatile memory device.

The storage controller 200 may transmit and receive signals to and from the nonvolatile memory device 300 in parallel through different channels. For example, the storage controller 200 may transmit the command CMDb to the nonvolatile memory device NVM21 through the second channel CH2 while transmitting the command CMDa to the nonvolatile memory device NVM11 through the first channel CH1. For example, the storage controller 200 may receive the data DATAb from the nonvolatile memory device NVM21 through the second channel CH2 while receiving the data DATAa from the nonvolatile memory device NVM11 through the first channel CH1.

FIG. 2 illustrates that the nonvolatile memory device 300 communicates with the storage controller 200 through m channels and that the nonvolatile memory device 300 includes n nonvolatile memory devices corresponding to each channel, but aspects are not limited thereto, and the number of channels and the number of nonvolatile memory devices connected to one channel may be variously changed.

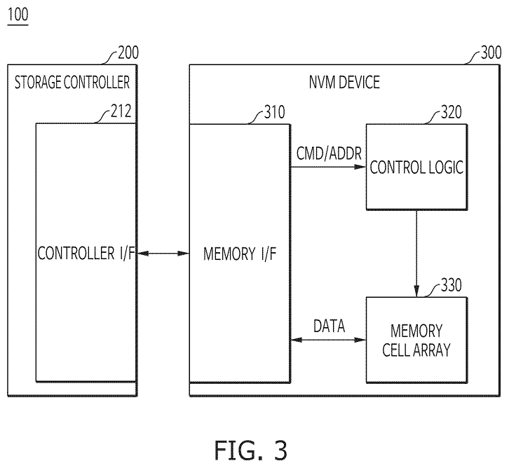

FIG. 3 is a block diagram provided to explain the storage device 100 according to some aspects. Descriptions that overlap with FIGS. 1 and 2 regarding the storage controller 200 will be omitted.

Referring to FIG. 3, the nonvolatile memory device 300 may include a memory interface 310, a control logic 320, and a memory cell array 330. The nonvolatile memory device 300 may correspond to one of the nonvolatile memory devices NVM11 to NVMmn communicating with the storage controller 200 of FIG. 2 based on one of the plurality of channels CH1 to CHm of FIG. 2.

The memory interface 310 may provide an interface between the nonvolatile memory device 300 and the storage controller 200. For example, the nonvolatile memory device 300 may receive a command CMD, an address ADDR, and data DATA from the storage controller 200 through the memory interface 310 or transmit the data DATA stored in the memory cell array 330 to the storage controller 200. In addition, the nonvolatile memory device 300 may transmit peak information associated with the command CMD to the storage controller 200 through the memory interface 310.

The control logic 320 may comprehensively control various operations of the nonvolatile memory device 300. The control logic 320 may receive a command/address CMD/ADDR obtained from the memory interface 310. The control logic 320 may generate control signals for controlling other components of the nonvolatile memory device 300 according to the received command/address CMD/ADDR. For example, the control logic 320 may generate various control signals for programming the data DATA in the memory cell array 330 or for reading the data DATA from the memory cell array 330. Alternatively, control signals for adjusting a channel potential in the memory cell array 330 may be generated.

The memory cell array 330 may store the data DATA obtained from the memory interface 310 under the control of the control logic 320. The memory cell array 330 may output the stored data DATA to the memory interface 310 under the control of the control logic 320. In addition, the channel potential in the memory cell array 330 may be adjusted under the control of the control logic 320.

The memory cell array 330 may include a plurality of memory cells. For example, the plurality of memory cells may be flash memory cells. However, aspects are not limited to the above, and the memory cells may be Resistive Random Access Memory (RRAM) cells, Ferroelectric Random Access Memory (FRAM) cells, Phase Change Random Access Memory (PRAM) cells, Thyristor Random Access Memory (TRAM) cells, and Magnetic Random Access Memory (MRAM) cells. The memory cells will be described below with reference to the examples of NAND flash memory cells.

FIG. 3 illustrates that the nonvolatile memory device 300 includes the memory interface 310, the control logic 320, and the memory cell array 330, but aspects are not limited thereto, and the nonvolatile memory device 300 may further include components that perform various functions.

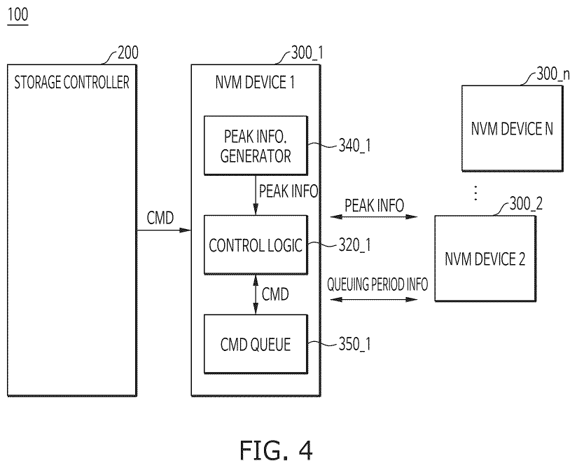

FIG. 4 is a block diagram provided to explain a detailed configuration of the nonvolatile memory device 300_1. Each of nonvolatile memory devices 300_2 to 300_n may be implemented similarly to the detailed configuration of the nonvolatile memory device 300_1. Referring to FIG. 4, the nonvolatile memory device 300_1 may include a peak information generator 340_1, a control logic 320_1, and a command queue 350_1.

The peak information generator 340_1 may receive the command CMD from the storage controller 200 and, in response to receiving the command CMD, generate peak information (Peak Info) associated with the command CMD. Alternatively, the peak information generator 340_1 may receive the command CMD from the control logic 320_1 and, in response, generate peak information (Peak Info) associated with the command CMD. The peak information generator 340_1 may transmit the generated peak information (Peak Info) to the control logic 320_1. The nonvolatile memory device 300_1 may transmit the generated peak information (Peak Info) to at least some of the nonvolatile memory devices 300_2 to 300_n or may receive the peak information (Peak Info) generated from at least some of the nonvolatile memory devices 300_2 to 300_n.

The peak information (Peak Info) associated with the command CMD may include a first signal indicating a peak period associated with the command CMD and a second signal indicating a non-peak period associated with the command CMD. For example, when the nonvolatile memory device 300_1 executes the command CMD, if it enters the peak period, the first signal may be activated and may have a logic high level. For example, when the nonvolatile memory device 300_1 executes the command CMD, if it does not enter the peak period, the second signal may be activated and may have a logic low level. However, aspects are not limited to the above, and the first signal may have a logic low level when activated and the second signal may have a logic high level when activated.

The peak information generator 340_1 may be implemented as a circuit for generating a flag signal based on whether the nonvolatile memory device 300_1 enters the peak period, but aspects are not limited thereto.

The control logic 320_1 may receive the peak information (Peak Info) from the peak information generator 340_1. In addition, the control logic 320_1 may receive the peak information (Peak Info) from at least some of the nonvolatile memory devices 300_2 to 300_n. For convenience, in the description of FIG. 4, the peak information (Peak Info) received from the peak information generator 340_1 will be referred to as first peak information, and the peak information (Peak Info) received from the nonvolatile memory device 300_2 will be referred to as second peak information.

The control logic 320_1 may queue the command CMD in the command queue 350_1 based on the first peak information and the second peak information, and determine an execution time point of the command CMD based on the second peak information. For example, the control logic 320_1 may determine whether the peak periods of the nonvolatile memory device 300_1 and the nonvolatile memory device 300_2 overlap with each other based on the first peak information and the second peak information. If it is determined that the peak periods of the nonvolatile memory device 300_1 and the nonvolatile memory device 300_2 overlap with each other, the control logic 320_1 may queue the command CMD in the command queue 350_1 without initiating the execution of the command CMD. In addition, the control logic 320_1 may determine whether the peak period of the nonvolatile memory device 300_2 has ended or not based on the second peak information, and if it is determined that the peak period of the nonvolatile memory device 300_2 has ended, may initiate the execution of the command CMD queued in the command queue 350_1.

As another example, the control logic 320_1 may determine whether the peak period of the nonvolatile memory device 300_2 has ended or not based on the second peak information. If it is determined that the peak period of the nonvolatile memory device 300_2 not not ended, the control logic 320_1 may queue the command CMD in the command queue 350_1 without initiating the execution of the command CMD. In addition, in response to determining that the peak period of the nonvolatile memory device 300_2 has ended, the control logic 320_1 may initiate the execution of the command CMD queued in the command queue 350_1.

Additionally, the control logic 320_1 may determine an execution time point of the command CMD and generate queuing period information (Queuing Period Info) associated with the execution time point of the command CMD. The nonvolatile memory device 300_1 may transmit the queuing period information (Queuing Period Info) associated with the execution time point of the command CMD, generated by the control logic 320_1, to at least some of the nonvolatile memory devices 300_2 to 300_n, or may receive the queuing period information (Queuing Period Info) generated by at least some of the nonvolatile memory devices 300_2 to 300_n.

The queuing period information (Queuing Period Info) associated with the command CMD may include a first signal indicating the presence of a queued command CMD, and a second signal indicating the absence of a queued command CMD. Like the peak information (Peak Info), each of the first signal and the second signal included in the queuing period information (Queuing Period Info) may have a logic high level or a logic low level.

FIG. 4 illustrates that the peak information (Peak Info) and the queuing period information (Queuing Period Info) are separate signals, but aspects are not limited thereto. For example, the peak information (Peak Info) and the queuing period information (Queuing Period Info) may be implemented in the form of a single signal. For example, the first signal may be activated if the nonvolatile memory device is operating in the peak period or if there is a queued command in the command queue; otherwise, the second signal may be activated.

The nonvolatile memory device 300_1 may further generate a ready/busy signal indicating a busy state in which an internal operation is being performed or a ready state in which the internal operation is complete, and the nonvolatile memory device 300_1 may further determine an execution time point of the command CMD based on the ready/busy signal. For example, the control logic 320_1 may generate the ready/busy signal and determine the execution time point of the command CMD based on the ready/busy signal, the peak information (Peak Info), and/or the queuing period information (Queuing Period Info).

FIG. 4 illustrates that the peak information generator 340_1 and the control logic 320_1 are different configurations, but aspects are not limited thereto. For example, the peak information generator 340_1 may be included in the control logic 320_1 or may be implemented as part of the control logic 320_1.

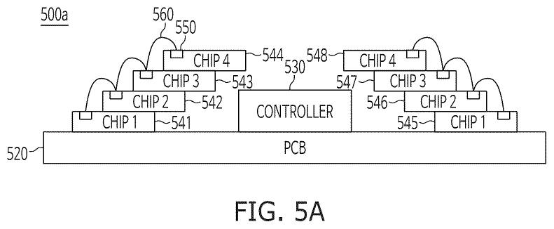

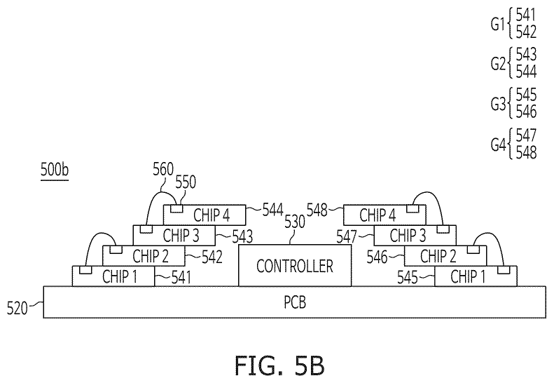

FIG. 4 illustrates that only the nonvolatile memory device 300_1 transmits and receives the peak information (Peak Info) to and from the nonvolatile memory devices 300_2 to 300_n, but aspects are not limited thereto. For example, each of nonvolatile memory devices 300_1 to 300_n may transmit and receive the peak information to and from each other. Various aspects will be described in detail below with reference to FIGS. 5 to 7, in which each of the nonvolatile memory devices 300_1 to 300_n transmits and receives the peak information.

FIG. 5A is a diagram provided to explain a structure for sharing information among a plurality of memory chips 541 to 548. FIG. 5B is a diagram provided to explain a structure for sharing information among the plurality plurality of memory chips 541 to 548. A storage controller 530 may correspond to the storage controller 200 of FIGS. 1 to 4. Each of the plurality of memory chips 541 to 548 may correspond to the nonvolatile memory device 300 of FIGS. 1 to 4. Alternatively, each of the plurality of memory chips 541 to 548 may include the plurality of nonvolatile memory devices 300.

Storage devices 500a and 500b may include a printed circuit board 520, the storage controller 530 mounted on the printed circuit board 520, and the plurality of memory chips 541 to 548. Each of the plurality of memory chips 541 to 548 may include a data input/output pad 550 for sharing peak information and/or queuing period information. The data input/output pad 550 of each of the plurality of memory chips 541 to 548 may be electrically connected to each other through a bonding wire 560. Each of the plurality of memory chips 541 to 544 may transmit the peak information and/or the queuing period information to another memory chip (e.g., a next memory chip with a lower priority) through the data input/output pad 550 and the bonding wire 560, and receive the peak information and/or the queuing period information from another memory chip (e.g., a next memory chip with a higher priority). A plurality of memory chips 545 to 548 may correspond to the plurality of memory chips 541 to 544.

Referring to FIG. 5A, the plurality of memory chips 541 to 544 may transmit/receive the peak information and/or the queuing period information in a master-slave manner. For example, the fourth memory chip 544 may have a higher priority than the third memory chip 543, the third memory chip 543 may have a higher priority than the second memory chip 542, and the second memory chip 542 may have a higher priority than the first memory chip 541. In this case, the fourth memory chip 544 may transmit its peak information and/or queuing period information to the third memory chip 543, the third memory chip 543 may transmit its peak information and/or queuing period information to the second memory chip 542, and the second memory chip 542 may transmit its peak information and/or queuing period information to the first memory chip 541. That is, each of the plurality of memory chips 541 to 544 may receive the peak information and/or the queuing period information of a memory chip with one level higher priority, and transmit the peak information and/or the queuing period information to a memory chip with one level lower priority.

Referring to FIG. 5B, the plurality of memory chips 541 to 548 may form a plurality of groups G1 to G4 to transmit and receive peak information. For example, the memory chips 541 and 542 may belong to a first group G1, the memory chips 543 and 544 may belong to a second group G2, the memory chips 545 and 546 may belong to a third group G3, and the memory chips 547 and 548 may belong to a fourth group G4.

If the plurality of memory chips 541 to 548 form the plurality of groups G1 to G4 to transmit and receive the peak information, the plurality of memory chips in the group may transmit and receive the peak information in the master-slave manner. For example, in the first group G1, the memory chip 542 may have a higher priority than the memory chip 541, in the second group G2, the memory chip 544 may have a higher priority than the memory chip 543, in the third group G3, the memory chip 546 may have a higher priority than the memory chip 545, and in the fourth group G4, the memory chip 548 may have a higher priority than the memory chip 547. In this case, the memory chip 542 may transmit the peak information and/or the queuing period information to the memory chip 541, the memory chip 544 may transmit the peak information and/or the queuing period information to the memory chip 543, the memory chip 546 may transmit the peak information and/or the queuing period information to the memory chip 545, and the memory chip 548 may transmit the peak information and/or the queuing period information to the memory chip 547. That is, each of the plurality of memory chips 541 to 548 may receive the peak information and/or the queuing period information of a memory chip with one level higher priority within the same group, and transmit the peak information and/or the queuing period information to a memory chip with one level lower priority within the same group.

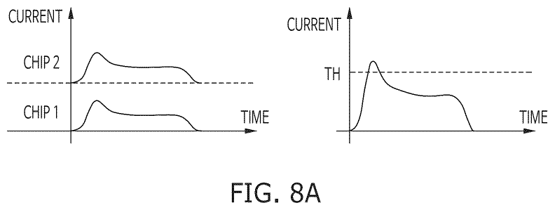

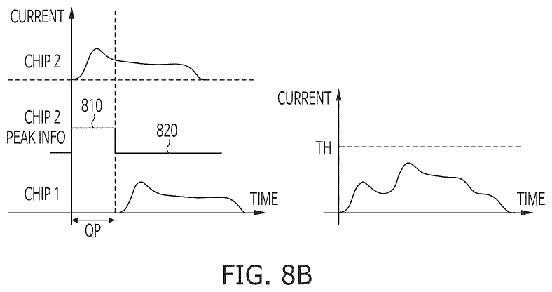

Referring to FIGS. 5A and 5B, with a configuration in which each of the plurality of memory chips 541 to 548 includes a single data input/output pad 550 and is connected in a master-slave manner, it is possible to implement the command queuing and execution operation at the memory chip level without intervention of the storage controller 530. This operation will be described in detail below with reference to FIGS. 8 to 11.

FIGS. 5A and 5B illustrate that the storage devices 500a and 500b include only eight memory chips, but aspects are not limited thereto. In addition, FIGS. 5A and 5B illustrate that four memory chips are stacked on both sides of the printed circuit board 520, but aspects are not limited thereto. Accordingly, the storage devices 500a and 500b may further include any number of memory chips, and the number of memory chips in the stack may also be changed to any number.

FIG. 5B illustrates that two memory chips are included in one group, but aspects are not limited thereto. Accordingly, any number of memory chips may be included in one group, and the number of memory chips included in each group may also vary.

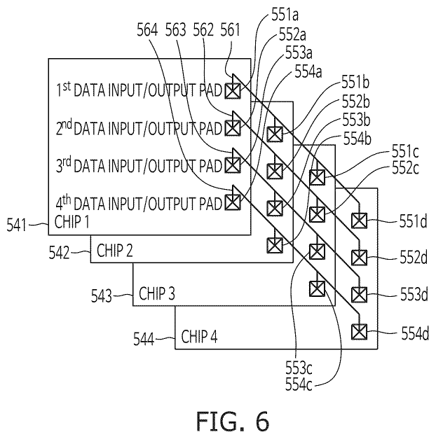

FIG. 6 is a diagram provided to explain a structure for sharing information among the plurality plurality of memory chips 541 to 544. Referring to FIG. 6, each of the plurality of memory chips 541 to 544 may include a plurality of data input/output pads 551a to 554d for sharing the peak information and/or the queuing period information.

The plurality of data input/output pads 551a to 554d may include first data input/output pads 551a to 551d for sharing the peak information and/or the queuing period information of the first memory chip 541, second data input/output pads 552a to 552d for sharing the peak information and/or the queuing period information of the second memory chip 542, third data input/output pads 553a to 553d for sharing the peak information and/or the queuing period information of the third memory chip 543, and fourth data input/output pads 554a to 554d for sharing the peak information and/or the queuing period information of the fourth memory chip 544.

The first data input/output pads 551a to 551d for sharing the peak information and/or the queuing period information of the first memory chip 541 may be electrically connected to each other through a first bonding wire 561, and the second data input/output pads 552a to 552d for sharing the peak information and/or the queuing period information of the second memory chip 542 may be electrically connected to each other through a second bonding wire 562. In addition, the third data input/output pads 553a to 553d for sharing the peak information and/or the queuing period information of the third memory chip 543 may be electrically connected through a third bonding wire 563, and the fourth data input/output pads 554a to 554d for sharing the peak information and/or the queuing period information of the fourth memory chip 544 may be electrically connected through a fourth bonding wire 564. That is, the number of data input/output pads included in each of the plurality of memory chips 541 to 544 may correspond to the number of the plurality of memory chips 541 to 544.

As an example, a process of sharing the peak information and/or the queuing period information of the first memory chip 541 will be described. For example, the fourth memory chip 544 may have a higher priority than the third memory chip 543, the third memory chip 543 may have a higher priority than the second memory chip 542, and the second memory chip 542 may have a higher priority than the first memory chip 541.

The first memory chip 541 may transmit the peak information and/or the queuing period information of the first memory chip 541 to the second to fourth memory chips 542, 543, and 544 through the first data input/output pad 551a. Accordingly, each of the second to fourth memory chips 542, 543, and 544 may receive the peak information and/or the queuing period information of the first memory chip 541 through first data input/output pads 551b, 551c, and 551d. That is, only the peak information and/or the queuing period information of the first memory chip 541 may be transmitted and received through the first data input/output pads 551a to 551d. In an example, the second to fourth memory chips 542 to 544 may determine that the peak information and/or the queuing period information received through the first data input/output pads 551a to 551d are transmitted from the first memory chip 541 with a lower priority.

Similarly, the first memory chip 541 may determine that the peak information and/or the queuing period information received through the second data input/output pad 552a are transmitted from the second memory chip 542 with a higher priority, and each of the third and fourth memory chips 543 and 544 may determine that the peak information and/or the queuing period information received through second data input/output pads 552c and 552d are transmitted from the second memory chip 542 with a lower priority.

According to some aspects, with a configuration in which each of the plurality of memory chips 541 to 544 includes a plurality of data input/output pads 551 to 554, and the plurality of memory chips 541 to 544 are interconnected to each other, it is possible to implement the command queuing and execution operation at the memory chip level without intervention of the storage controller 530. Detailed examples of the command queuing and execution operation will be described in detail below with reference to FIGS. 8 to 11.

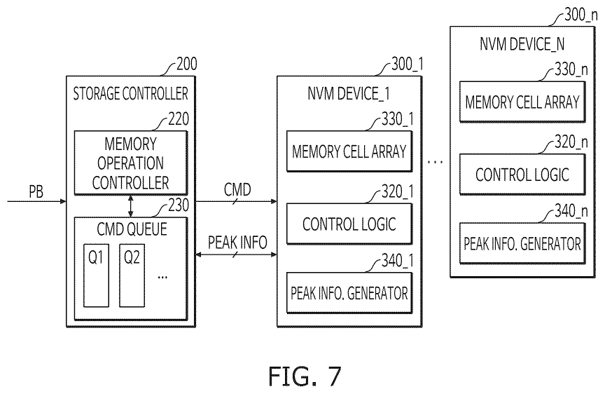

FIG. 7 is a block diagram provided to explain detailed configurations of the storage controller 200 and the nonvolatile memory devices 300_1 to 300_n. The storage controller 200 may correspond to the storage controller 200 of FIGS. 1 to 4. Each of the plurality of nonvolatile memory devices 300_1 to 300_n may correspond to the nonvolatile memory device 300 of FIG. 2.

Referring to FIG. 7, the storage controller 200 may include a memory operation controller 220 and a command queue 230. The storage controller 200 may further include an additional configuration. The storage controller 200 may receive a power budget PB from an external device. The external device may be the host 20 of FIG. 1 or the power management module 23 included in the host 20, but is not limited thereto. In addition, the storage controller 200 may transmit the command CMD to the nonvolatile memory devices 300_1 to 300_n and receive the peak information (Peak Info) generated by peak information generators 340_1 to 340_n of the nonvolatile memory devices 300_1 to 300_n from the nonvolatile memory devices 300_1 to 300_n.

The memory operation controller 220 may queue, in the command queue 230, at least some of the commands CMD to be executed by the nonvolatile memory devices 300_1 to 300_n based on the power budget PB received from the external device and the peak information (Peak Info) received from the plurality of nonvolatile memory devices 300_1 to 300_n, and determine the execution time point at which the nonvolatile memory devices 300_1 to 300_n executes the command CMD.

For example, the memory operation controller 220 may calculate, based on the peak information (Peak Info), the number of nonvolatile memory devices entering the current peak period or the sum of the peak currents of each of the nonvolatile memory devices entering the peak period, and may determine a time point for transmitting the command CMD to the nonvolatile memory device to ensure that the set power budget PB is not exceeded. That is, if it is determined that transmitting the command CMD to a specific nonvolatile memory device will exceed the power budget PB, the memory operation controller 220 may queue the command CMD in the command queue 230 without transmitting the command CMD to the nonvolatile memory device. If it is determined that the peak period has ended, the memory operation controller 220 may transmit the command CMD queued in the command queue 230 to the nonvolatile memory device.

Each of the plurality of nonvolatile memory devices 300_1 to 300_n may include memory cell arrays 330_1 to 330_n, control logics 320_1 to 320_n, and peak information generators 340_1 to 340_n.

The control logics 320_1 to 320_n may receive the command CMD from the storage controller 200 and, in response to receiving the command CMD, execute the command CMD on the memory cell arrays 330_1 to 330_n. In addition, the control logics 320_1 to 320_n may control the peak information generators 340_1 to 340_n so that the peak information generators 340_1 to 340_n generate peak information (Peak Info) associated with the command CMD.

The peak information generators 340_1 to 340_n may generate the peak information (Peak Info) under the control of the control logics 320_1 to 320_n, and transmit the generated peak information to the storage controller 200. FIG. 7 illustrates that the peak information generators 340_1 to 340_n are separate configurations from the control logics 320_1 to 320_n, but aspects are not limited thereto, and the peak information generators 340_1 to 340_n and the control logics 320_1 to 320_n may be integrated.

FIGS. 8A and 8B are diagrams illustrating examples of command queuing and execution operations of the memory chips 541 and 542 of FIGS. 5A, 5B, and 6 or the storage controller 200 of FIG. 7 according to some aspects.

Referring to FIG. 8A, a first memory chip and a second memory chip may receive the commands CMD and execute the commands at the same time. In this case, the peak periods of the first memory chip and the second memory chip may overlap with each other. In an example, the commands CMD allocated to each of the first memory chip and the second memory chip may be at least some of a plurality of commands for multi-speed operation. For example, the plurality of commands for the multi-speed operation may be read commands. In this case, the amount of current required for the operation of each of the first memory chip and the second memory chip may initially have a peak value.

As described above, if the peak periods of the first and second memory chips overlap with each other, the total amount of current of a storage device (e.g., the storage device 100 of FIG. 1) including the first and second memory chips may be higher than a predetermined threshold TH, which may degrade the performance of the storage device 100. The predetermined threshold TH may correspond to the power budget PB managed by the power management module (e.g., the power management module 23 of FIG. 1).

Referring to FIG. 8B, in an aspect in which commands are queued at the memory chip level, the first and second memory chips may receive the command CMD at the same time. In an example, the second memory chip may have a higher priority than the first memory chip. The second memory chip having the higher priority may directly execute a second command upon receiving the second command from the storage controller 200. In addition, the second memory chip may generate peak information (Chip 2 Peak Info) associated with the second command and transmit the peak information to the first memory chip.

The first memory chip may receive the peak information (Chip 2 Peak Info) associated with the second command from the second memory chip, and, based on the peak information of the second memory chip, may queue the first command in the first command queue without executing the first command. In an example, the peak information of the second memory chip may include a first signal 810 indicating a peak period associated with the second command and a second signal 820 indicating a non-peak period associated with the second command. Specifically, if the peak period of the first memory chip overlaps with the peak period of the second memory chip, the first memory chip may queue the first command in the first command queue during a queuing period QP without executing the first command. The queuing period QP may correspond to the peak period associated with the second command. The first memory chip may determine whether the peak period of the second memory chip has ended or not based on the peak information (Chip 2 Peak Info) associated with the second command, and, in response to determining that the peak period of the second memory chip has ended, may initiate the execution of the first command. As a result, the total amount of currents of the storage device 100 may be lower than the predetermined threshold TH, and the power consumed by the storage device 100 may be managed to remain below the power budget PB.

In an aspect in which the storage controller 200 queues commands, the storage controller 200 may transmit the second command to the second memory chip based on the predetermined threshold TH, and queue the first command in the command queue (e.g., 230 of FIG. 7) without transmitting the first command to the first memory chip. In addition, the storage controller 200 may receive the peak information (Chip 2 Peak Info) associated with the second command from the second memory chip, and determine whether the peak period of the second memory chip has ended or not based on the peak information (Chip 2 Peak Info) associated with the second command. In response to determining that the peak period of the second memory chip has ended, the storage controller 200 may transmit the first command queued in the command queue to the first memory chip. As a result, the total amount of currents of the storage device 100 may be lower than the predetermined threshold TH, and the power consumed by the storage device 100 may be managed to remain below the power budget PB.

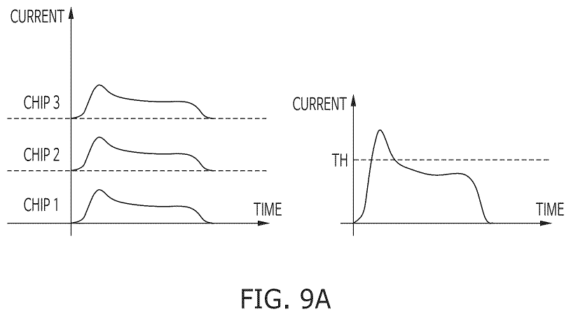

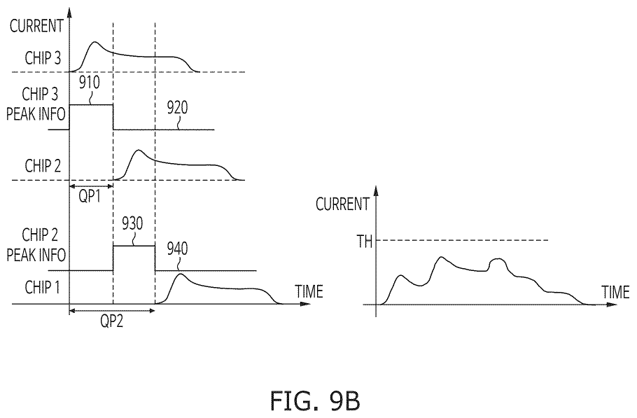

FIGS. 9A and 9B are diagrams illustrating examples of command queuing and execution operations of the memory chips 541 and 542 of FIGS. 5A, 5B, and 6 or the storage controller 200 of FIG. 7 according to some aspects.

Referring to FIG. 9A, the first memory chip, the second memory chip, and the third memory chip may receive the command CMD and execute the commands at the same time. In this case, the peak periods of the first to third memory chips may overlap with each other. For example, if the peak periods of two memory chips overlap with each other, the total amount of currents in the storage device 100 may be higher than the predetermined threshold TH, which may degrade the performance of the storage device 100.

Referring to FIG. 9B, in an aspect in which commands are queued at the memory chip level, the second memory chip may receive peak information (Chip 3 Peak Info) associated with a third command, and, based on the peak information of the third memory chip, may queue the second command in the second command queue without executing the second command. In an example, the peak information of the third memory chip may include a first signal 910 indicating a peak period associated with the third command, and a second signal 920 indicating a non-peak period associated with the third command. In addition, based on queuing period QP1 information associated with the execution time point of the second command and the peak information (Chip 2 Peak Info) associated with the second command, the first memory chip may queue the first command in the first command queue without executing the first command. In an example, the peak information of the second memory chip may include a third signal 930 indicating a peak period associated with the second command and a fourth signal 940 indicating a non-peak period associated with the second command. In addition, the queuing period information (QP1 information) associated with the execution time point of the second command may include information on a period during which the second memory chip queues the second command in the second command queue without executing the second command. The third memory chip may have a higher priority than the second memory chip, and the second memory chip may have a higher priority than the first memory chip. Furthermore, the first memory chip, the second memory chip, and the third memory chip may receive the command CMD at the same time.

Specifically, the third memory chip having the highest priority may directly execute the third command upon receiving the third command from the storage controller 200. In addition, the third memory chip may generate peak information (Chip 3 Peak Info) associated with the third command and transmit the peak information to the second memory chip.

The second memory chip having the second highest priority may determine that the peak period of the second memory chip and the peak period of the third memory chip overlap with each other based on the peak information (Chip 3 Peak Info) associated with the third command, and queue the second command in the second command queue without executing the second command during the queuing period QP1. The queuing period QP1 may correspond to a peak period associated with the third command. The second memory chip may determine whether the peak period of the third memory chip has ended or not based on the peak information (Chip 3 Peak Info) associated with the third command, and, in response to determining that the peak period of the third memory chip has ended, may initiate the execution of the second command. Additionally, the second memory chip may generate peak information (Chip 2 Peak Info) associated with the second command and transmit the peak information to the first memory chip. In addition, the second memory chip may transmit the queuing period QP1 information associated with the execution time point of the second command to the first memory chip.

The first memory chip having the lowest priority may determine that the second memory chip having a higher priority than the first memory chip is performing a command queuing operation based on the queuing period QP1 information associated with the execution time point of the second command, and, in response, may queue the first command in the first command queue without executing the first command. The first memory chip may determine that the peak period associated with the second command has not ended based on the peak information (Chip 2 Peak Info) associated with the second command, and queue the first command in the first command queue without executing the first command. Based on the queuing period QP1 information associated with the execution time point of the second command and/or the peak information (Chip 2 Peak Info) associated with the second command, the first memory chip may determine that the queued command is not present in the second command queue and the peak period associated with the second command has ended, and initiate the execution of the first command. In the illustrated example, the first memory chip may queue the first command in the first command queue without executing the first command during a queuing period QP2.

If the command queuing and execution operations described above are performed by a plurality of memory chips (e.g., the memory chips 541 to 548 of FIGS. 5A and 5B) that transmit and receive information in a master-slave manner, with a configuration in which only a single data input/output pad (e.g., the data input/output pad 550 of FIGS. 5A and 5B) is disposed in each of the plurality of memory chips, it is possible to implement the command queuing and execution operations at the memory chip level without the intervention of the storage controller. As a result, the power consumed by the storage device 100 may be managed to remain below the power budget PB.

In an aspect in which the storage controller 200 queues commands, the storage controller 200 may transmit the third command to the third memory chip having the highest priority based on the predetermined threshold TH, and queue the command in the command queue (e.g., 230 of FIG. 7) without transmitting the command to the second memory chip and the first memory chip.

In addition, the storage controller 200 may receive the peak information (Chip 3 Peak Info) associated with the third command from the third memory chip, and determine whether the peak period of the third memory chip has ended or not based on the peak information (Chip 3 Peak Info) associated with the third command. In response to determining that the peak period of the third memory chip has ended, the storage controller 200 may transmit the second command queued in the command queue to the second memory chip having the second highest priority.

The storage controller 200 may receive the peak information (Chip 2 Peak Info) associated with the second command from the second memory chip and, based on the peak information, determine a time point for transmitting the first command queued in the command queue to the first memory chip having the lowest priority.

As a result, the total amount of currents of the storage device 100 may be lower than the predetermined threshold TH, and the power consumed by the storage device 100 may be managed to remain below the power budget PB.

The third memory chip may complete the execution of the third command without delay from the time point at which the third command is executed, and, after the queuing period QP1, the second memory chip may complete the execution of the second command without delay from the time point at which the second command is executed. In addition, after the queuing period QP2, the first memory chip may complete the execution of the first command without delay from the time point at which the first command is executed. As a result, it is possible to ensure the uniformity of the busy period during which the command is executed.

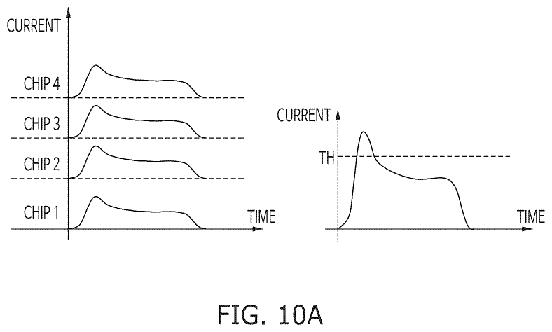

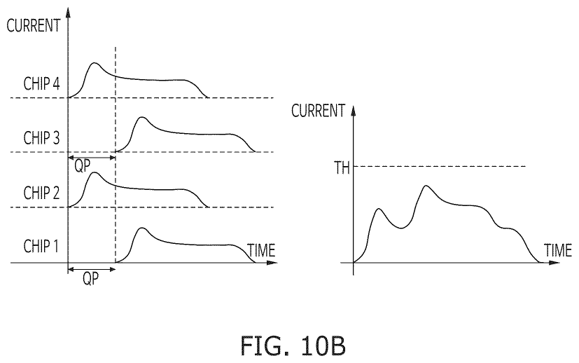

FIGS. 10A and 10B are diagrams illustrating examples of command queuing and execution operations of the memory chips 541 and 542 of FIGS. 5B and 6 or the storage controller 200 of FIG. 7 according to some aspects.

Referring to FIG. 10A, the first memory chip, the second memory chip, the third memory chip, and the fourth memory chip may receive the command CMD and execute the command at the same time. In this case, the peak periods of the first, second, third, and fourth memory chips may overlap with each other. In this case, if the peak periods of three or more memory chips overlap with each other, the total amount of currents of the storage device 100 may be higher than a predetermined threshold TH, which may degrade the performance of the storage device 100.

Referring to FIG. 10B, the first memory chip and the second memory chip may form a first group, and the third memory chip and the fourth memory chip may form a second group. The second memory chip may have a higher priority than the first memory chip, and the fourth memory chip may have a higher priority than the third memory chip.

In an aspect in which commands are queued at the memory chip level, each of the memory chips included in the first group and the second group may perform the command queuing and execution operations described above with reference to FIGS. 8B or 9B. In an aspect in which the storage controller 200 queues commands, the storage controller 200 may perform the command queuing and execution operations described above with reference to FIGS. 8B or 9B for each of the first group and the second group. As a result, the operation of the memory chips included in the first group and the operation of the memory chips included in the second group may be performed independently. FIG. 10B illustrates that there are two memory chip groups and that each group includes two memory chips, but aspects are not limited thereto. Accordingly, three or more memory chip groups may be formed, and three or more memory chips may be included in each group.

The number of memory chip groups may be determined based on the power budget PB. For example, based on the power budget PB, if overlapping of the peak periods of three or less memory chips is allowed, a plurality of memory chips included in the storage device 100 may be grouped into three groups. Since it may be managed such that the peak period of one memory chip is maintained per group, the power consumed by the storage device 100 may be managed to remain below the power budget PB.

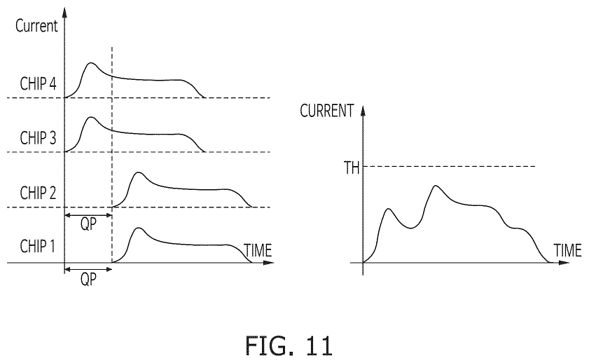

FIG. 11 is a diagram illustrating examples of the command queuing and execution operations of the memory chips 541, 542, 543, and 544 of FIG. 6 or the storage controller 200 of FIG. 7 according to some aspects. As illustrated in FIG. 10A, if peak periods of three or more memory chips overlap with each other, it is assumed that the total amount of currents of the storage device 100 is higher than the predetermined threshold TH.

In an aspect in which commands are queued at the memory chip level, the first to fourth memory chips may receive the command CMD at the same time and share the peak information through their respective first to fourth data input/output pads. In addition, the first and second memory chips may queue the first and second commands in the first and second command queues without executing the first and second commands based on peak information associated with a fourth command and peak information associated with the third command. The fourth memory chip may have a higher priority than the third memory chip, the third memory chip may have a higher priority than the second memory chip, and the second memory chip may have a higher priority than the first memory chip.

Specifically, the fourth memory chip having the highest priority may execute the fourth command upon receiving the fourth command from the storage controller 200. For example, based on the peak information received from the first, second, and third memory chips, the fourth memory chip may determine that there is no memory chip having a higher priority and operating in the peak period, and directly execute the fourth command.

The third memory chip having the second highest priority may execute the third command upon receiving the third command from the storage controller 200. For example, based on the peak information received from the first, second, and fourth memory chips, the third memory chip may determine that there is one memory chip having a higher priority and operating in the peak period and that the number of memory chips operating in the peak period is less than two, and execute the third command.

The second memory chip having the third highest priority may queue the second command in the second command queue without executing the second command upon receiving the second command from the storage controller 200. For example, based on the peak information received from the first, third, and fourth memory chips, the second memory chip may determine that there are two memory chips having a higher priority and operating in the peak period. In this case, the second memory chip may queue the second command in the second command queue without executing the second command during the queuing period QP. Based on the peak information received from the third memory chip and the fourth memory chip, the second memory chip may determine that the peak period of the third memory chip and the fourth memory chip has ended. In this case, the second memory chip may determine that there is no memory chip having a higher priority and operating in the peak period, and execute the second command.

The first memory chip having the lowest priority may queue the first command in the first command queue without executing the first command, when receiving the first command from the storage controller 200. For example, based on the peak information received from the second, third, and fourth memory chips, the first memory chip may determine that there are two memory chips having a higher priority and operating in the peak period. In this case, the first memory chip may queue the first command in the first command queue without executing the first command during the queuing period QP. Based on the peak information received from the second, third, and fourth memory chips, the first memory chip may determine that the number of memory chips having a higher priority and operating in the peak period is less than two, and execute the first command.

In an aspect in which the storage controller 200 queues commands, based on the predetermined threshold TH, the storage controller 200 may transmit the command CMD to some of the first to fourth memory chips, and queue the command CMD in the command queue (e.g., 230 of FIG. 7) without transmitting the command CMD to the other memory chips. In addition, the storage controller 200 may receive peak information from the memory chip that completed transmitting the command CMD, and, based on the received peak information, determine a time point for executing the command CMD queued in the command queue.

Specifically, if the peak periods of three or more memory chips overlap with each other, the storage controller 200 may determine that the total amount of current of the storage device 100 will be higher than the predetermined threshold TH, and transmit the command CMD to the fourth memory chip having the highest priority and the third memory chip having the second highest priority. In addition, the storage controller 200 may queue, in the command queue, a command CMD to be executed by the second memory chip having the third highest priority and the first memory chip having the lowest priority without transmitting the command CMD to the second memory chip and the first memory chip. In this case, the storage controller 200 may queue the command CMD in the command queue without transmitting the command CMD to the second memory chip and the first memory chip during the queuing period QP.

In addition, the storage controller 200 may receive the peak information from each of the fourth memory chip and the third memory chip that transmitted the command CMD. Based on the peak information received from the fourth memory chip and the third memory chip, the storage controller 200 may determine that the peak period of the fourth memory chip and the third memory chip has ended. In this case, since there are no memory chips operating in the peak period (or since there are fewer than two memory chips operating in the peak period), even if the command CMD is additionally transmitted to two memory chips, the storage controller 200 may determine that the total amount of currents of the storage device 100 may remain below the predetermined threshold TH. Accordingly, the storage controller 200 may transmit the command CMD queued in the command queue to each of the second memory chip and the first memory chip having lower priorities than the fourth memory chip and the third memory chip.

The predetermined threshold TH described above with reference to FIGS. 8A to 11 is not limited to the above, and may be variously changed according to the type of the storage device or the nonvolatile memory device.

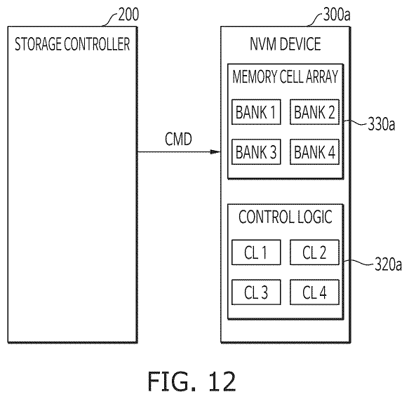

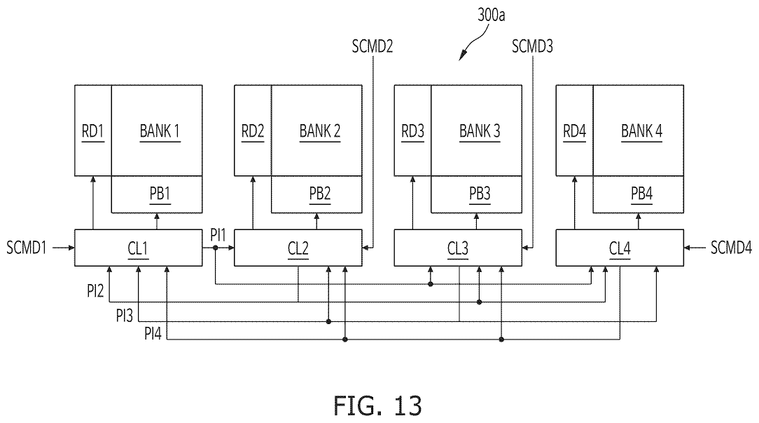

FIG. 12 is a block diagram provided to explain a detailed configuration of a nonvolatile memory device 300a. Referring to FIG. 12, the nonvolatile memory device 300a may correspond to a modification of the nonvolatile memory device 300 of FIG. 3, and the details described above with reference to FIGS. 1 to 11 may also be applied to this example. For example, if the memory chip described with reference to FIGS. 8A to 11 executes a command, sub-command queuing and execution operations described with reference to FIGS. 12 and 13 may be performed.

The nonvolatile memory device 300a may include a memory cell array 330a and a control logic 320a.

The memory cell array 330a may include first to fourth banks Bank 1 to Bank 4, and each of the first to fourth banks Bank 1 to Bank 4 may be a set of a plurality of memory cells included in the memory cell array 330a. However, aspects are not limited to the above, and the memory cell array 330a may include a plurality of banks. The number of banks included in the memory cell array 330a is not limited to four, and may be variously changed according to aspects. For example, the memory cell array 330a may include eight banks.

The control logic 320a may include first to fourth control logics CL1 to CL4. The first to fourth control logics CL1 to CL4 may correspond to the first to fourth banks Bank 1 to Bank 4, respectively, and may control the operations of the first to fourth banks Bank 1 to Bank 4, respectively.

The nonvolatile memory device 300a may receive a command CMD from the storage controller 200. The command CMD may include a first sub-command to be performed in the first bank (Bank 1), a second sub-command to be performed in the second bank (Bank 2), a third sub-command to be performed in the third bank (Bank 3), and a fourth sub-command to be performed in the fourth bank (Bank 4). Each of the first to fourth sub-commands may be transmitted to the first to fourth control logics CL1 to CL4.

FIG. 13 is a block diagram illustrating the nonvolatile memory device 300a of FIG. 12.

Referring to FIG. 13, the nonvolatile memory device 300a may further include the first to fourth banks Bank 1 to Bank 4, the first to fourth control logics CL1 to CL4, first to fourth page buffers PB1 to PB4, and first to fourth row decoders RD1 to RD4.

Each of the first to fourth control logics CL1 to CL4 may transmit a signal (e.g., a column address Y-ADDR and a row address X-ADDR) for controlling each of the first to fourth banks Bank 1 to Bank 4 to each of the first to fourth page buffers PB1 to PB4 or the first to fourth row decoders RD1 to RD4 to control the operation of each of the first to fourth banks Bank 1 to Bank 4.

The first control logic CL1 may receive a first sub-command SCMD1, and, in response to receiving the first sub-command SCMD1, may generate first peak information PI1 and transmit the first peak information to the second to fourth control logics CL2 to CL4. The first peak information PI1 may include a first signal (e.g., a logic high level) indicating a peak period associated with the first sub-command SCMD1, and a second signal (e.g., a logic low level) indicating a non-peak period associated with the first sub-command SCMD1. The first peak information PI1 may be implemented as a flag, but is not limited thereto.

Likewise, the second control logic CL2 may receive a second sub-command SCMD2, and, in response, generate second peak information PI2 and transmit the second peak information to the first control logic CL1, the third control logic CL3, and the fourth control logic CL4. The third control logic CL3 may receive a third sub-command SCMD3, and, in response, generate third peak information PI3 and transmit the third peak information to the first control logic CL1, the second control logic CL2, and the fourth control logic CL4. The fourth control logic CL4 may receive a fourth sub-command SCMD4, and, in response, generate fourth peak information PI4 and transmit the fourth peak information to the first to third control logics CL1 to CL3.

The first control logic CL1 may determine, based on the second to fourth peak information PI2 to PI4, whether the number of banks having a higher priority and operating in the peak period is less than a predetermined threshold. The predetermined threshold may correspond to the number of banks for which overlapping of the peak periods is allowed. If it is determined that the number of banks having a higher priority and operating in the peak period is greater than or equal to the predetermined threshold, the first control logic CL1 may queue the first sub-command SCMD1 in the first sub-command queue without executing the first sub-command SCMD1. If it is determined that the number of banks having a higher priority and operating in the peak period is less than the predetermined threshold due to any of the banks having a higher priority exiting the peak period, the first control logic CL1 may initiate the execution of the first sub-command SCMD1 queued in the first sub-command queue. The sub-command queuing and execution operations described above may also be performed by the second to fourth control logics CL2 to CL4.

FIG. 13 illustrates that all of the first to fourth control logics CL1 to CL4 share the peak information with each other, but aspects are not limited thereto. For example, the first to fourth control logics CL1 to CL4 may transmit and receive information in one direction, as in the master-slave manner of FIG. 5A, or may transmit and receive information by forming a plurality of groups as illustrated in FIG. 5B.

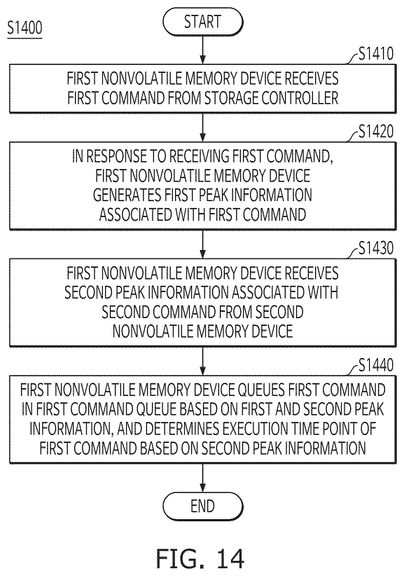

FIG. 14 is a flowchart provided to explain a method for operating a nonvolatile memory device. A method S1400 may be performed by a first nonvolatile memory device included in the storage device, and the storage device may include the first nonvolatile memory device and a second nonvolatile memory device.

The method S1400 may be initiated by the first nonvolatile memory device receiving the first command from the storage controller, at S1410. In response to receiving the first command, the first nonvolatile memory device may generate first peak information associated with the first command, at S1420.

The first nonvolatile memory device may receive second peak information associated with the second command from the second nonvolatile memory device, at S1430. The second peak information may include a first signal indicating a peak period associated with the second command, and a second signal indicating a non-peak period associated with the second command.

The first nonvolatile memory device may queue the first command in the first command queue based on the first peak information and the second peak information, and determine an execution time point of the first command based on the second peak information, at S1440.

The first nonvolatile memory device may determine whether the peak period associated with the second command has ended or not based on the second peak information, and, in response to determining that the peak period associated with the second command has ended, may initiate the execution of the first command.

The second nonvolatile memory device may complete the execution of the second command without delay from the time point at which the second command is executed. For example, the second nonvolatile memory device may have a higher priority than the first nonvolatile memory device.

The flowchart and description described above with reference with FIG. 14 are merely examples and may be implemented differently in some aspects. For example, in some examples, the order of respective operations may be changed, some of the operations may be repeatedly performed, some may be omitted, or some may be added.

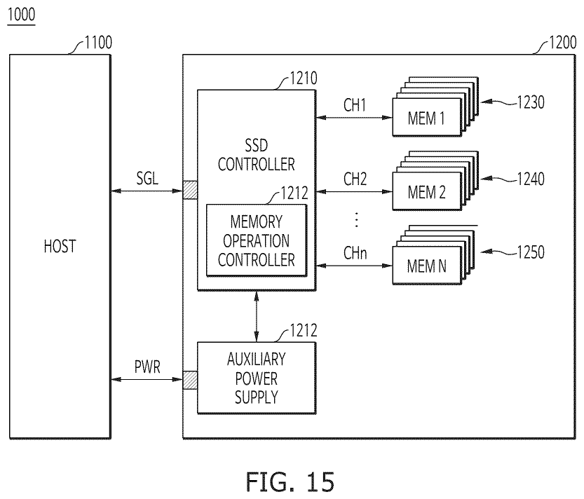

FIG. 15 is a block diagram illustrating an example in which a storage device according to some aspects is applied to an SSD system 1000.

Referring to FIG. 15, the SSD system 1000 may include a host 1100 and an SSD 1200. The SSD 1200 may transmit and receive signals to and from the host 1100 through a signal connector, and receive power through a power connector. The SSD 1200 may include an SSD controller 1210, an auxiliary power supply 1220, and a plurality of memory devices 1230, 1240, and 1250. In this case, the SSD 1200 may be implemented using the aspects illustrated in FIGS. 1 to 14.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination

1. A storage device, comprising:
a plurality of nonvolatile memory devices comprising a first nonvolatile memory device and a second nonvolatile memory device; and
a storage controller configured to control the plurality of nonvolatile memory devices, wherein
the storage controller is configured to transmit a first command to the first nonvolatile memory device and a second command to the second nonvolatile memory device,
the first nonvolatile memory device is configured to generate, based on receiving the first command, first peak information associated with the first command,
the second nonvolatile memory device is configured to generate, based on receiving the second command, second peak information associated with the second command and transmit the second peak information to the first nonvolatile memory device, and
the first nonvolatile memory device is configured to queue the first command in a first command queue based on the first peak information and the second peak information, and to determine an execution time point of the first command based on the second peak information.

2. The storage device according to claim 1, wherein
the first nonvolatile memory device comprises a memory cell array comprising a plurality of memory cells, and a control logic configured to control an operation of the memory cell array, wherein
the control logic is configured to
determine whether a peak period associated with the second command has ended based on the second peak information, and
initiate, based on determining that the peak period associated with the second command has ended, execution of the first command for the memory cell array.

3. The storage device according to claim 1, wherein the second peak information comprises a first signal indicating a peak period associated with the second command, and a second signal indicating a non-peak period associated with the second command.

4. The storage device according to claim 1, wherein
the plurality of nonvolatile memory devices further comprise a third nonvolatile memory device,
the storage controller is configured to transmit a third command to the third nonvolatile memory device,
the third nonvolatile memory device is configured to generate, based on receiving the third command, third peak information associated with the third command and transmit the third peak information to the second nonvolatile memory device,
the second nonvolatile memory device is configured to
queue the second command in a second command queue based on the second peak information and the third peak information,
determine an execution time point of the second command based on the third peak information, and
transmit queuing period information associated with the execution time point of the second command to the first nonvolatile memory device, and
the first nonvolatile memory device is configured to
queue the first command in the first command queue based on the queuing period information, and
determine the execution time point of the first command further based on the queuing period information.

5. The storage device according to claim 4, wherein the first nonvolatile memory device is configured to
determine whether there is a queued command in the second command queue based on the queuing period information,
determine whether a peak period associated with the second command has ended based on the second peak information, and
initiate, based on determining that the queued command is not present in the second command queue and that the peak period associated with the second command has ended, execution of the first command.

6. The storage device according to claim 4, wherein the third nonvolatile memory device is configured to execute the third command based on receiving the third command.

7. The storage device according to claim 1, wherein
the plurality of nonvolatile memory devices further comprise a third nonvolatile memory device and a fourth nonvolatile memory device,
the first nonvolatile memory device and the second nonvolatile memory device belong to a first group, and the third nonvolatile memory device and the fourth nonvolatile memory device belong to a second group,
the storage controller is configured to transmit a third command to the third nonvolatile memory device and a fourth command to the fourth nonvolatile memory device,
based on receiving the third command, the third nonvolatile memory device is configured to generate third peak information associated with the third command,
based on receiving the fourth command, the fourth nonvolatile memory device is configured to generate fourth peak information associated with the fourth command and transmit the fourth peak information to the third nonvolatile memory device, and
the third nonvolatile memory device is configured to queue the third command in a third command queue based on the third peak information and the fourth peak information, and determine an execution time point of the third command based on the fourth peak information.

8. The storage device according to claim 1, wherein
the plurality of nonvolatile memory devices further comprise a third nonvolatile memory device,
the first nonvolatile memory device is configured to transmit the first peak information to the second nonvolatile memory device and the third nonvolatile memory device,
the second nonvolatile memory device is configured to transmit the second peak information to the third nonvolatile memory device,
the storage controller is configured to transmit a third command to the third nonvolatile memory device, and
based on receiving the third command, the third nonvolatile memory device is configured to generate third peak information associated with the third command and transmit the third peak information to the first nonvolatile memory device and the second nonvolatile memory device.

9. The storage device according to claim 8, wherein each of the first nonvolatile memory device, the second nonvolatile memory device, and the third nonvolatile memory device comprises a first data input/output pad for sharing the first peak information, a second data input/output pad for sharing the second peak information, and a third data input/output pad for sharing the third peak information.

10. The storage device according to claim 8, wherein
the third nonvolatile memory device is configured to execute the third command based on receiving the third command.

11. The storage device according to claim 10, wherein the second nonvolatile memory device is configured to determine whether to queue the second command based on the second peak information, the third peak information, and a predetermined threshold.

12. The storage device according to claim 10, wherein the first nonvolatile memory device is configured to determine whether to queue the first command based on the first peak information, the second peak information, the third peak information, and a predetermined threshold.

13. The storage device according to claim 1, wherein the first command and the second command comprise commands for multi-speed operation.

14. The storage device according to claim 13, wherein the commands for multi-speed operation comprise read commands.

15. The storage device according to claim 1, wherein
the first nonvolatile memory device comprises
a first bank and a second bank, and
a first control logic and a second control logic configured to control operations of the first bank and the second bank, respectively,
the first command comprises a first sub-command to be performed in the first bank and a second sub-command to be performed in the second bank,
the first control logic is configured to generate peak information associated with the first sub-command based on the first sub-command,
the second control logic is configured to generate peak information associated with the second sub-command based on the second sub-command and transmit the peak information associated with the second sub-command to the first control logic, and
the first control logic is configured to queue the first sub-command in a sub-command queue based on the peak information associated with the first sub-command and the peak information associated with the second sub-command, and determine an execution time point of the first sub-command based on the peak information associated with the second sub-command.

16. The storage device according to claim 1, wherein the first nonvolatile memory device is configured to complete execution of the first command without delay from a time point at which the first command is executed.

17. The storage device according to claim 1, wherein
the first nonvolatile memory device is configured to generate a ready/busy signal indicating a busy state of performing an internal operation or a ready state in which an internal operation is completed, and
the first nonvolatile memory device is configured to determine the execution time point of the first command further based on the ready/busy signal.

18. A storage device, comprising:
a plurality of nonvolatile memory devices comprising a first nonvolatile memory device and a second nonvolatile memory device; and
a storage controller configured to control the plurality of nonvolatile memory devices, wherein the storage controller is configured to transmit a second command to the second nonvolatile memory device,
the second nonvolatile memory device is configured to generate, based on receiving the second command, second peak information associated with the second command and transmit the second peak information to the storage controller,
the storage controller is configured to queue a first command in a command queue based on a predetermined threshold and the second peak information, and determine a time point for executing the first command by the first nonvolatile memory device based on the second peak information,
the storage controller is configured to transmit the first command to the first nonvolatile memory device at the time point for executing the first command, and
the first nonvolatile memory device is configured to generate, based on receiving the first command, first peak information associated with the first command and transmit the first peak information to the storage controller.

19. The storage device according to claim 18, wherein the storage controller is configured to determine whether a peak period associated with the second command has ended based on the second peak information, and, based on determining that the peak period associated with the second command has ended, control the first nonvolatile memory device to initiate the execution of the first command.

20. A method performed by a first nonvolatile memory device, the method comprising:
receiving a first command from a storage controller;
based on receiving the first command, generating first peak information associated with the first command;
receiving second peak information associated with a second command from a second nonvolatile memory device;
queuing the first command in a first command queue based on the first peak information and the second peak information; and
determining an execution time point of the first command based on the second peak information.
